(19) United States
(12) Patent Application Publication
(10) Pub. No.: US 2025/0371698 A1
(43) Pub. Date: Dec. 4, 2025

(54) INK JET PRINTING APPARATUS AND METHOD

(71) Applicant: KEYENCE CORPORATION, Osaka (JP)

(72) Inventors: Mamoru Idaka, Osaka-shi (JP); Kentaro Yamazaki, Osaka-shi (JP); Hidetake Sasaki, Osaka-shi (JP)

(73) Assignee: KEYENCE CORPORATION, Osaka (JP)

(21) Appl. No.: 19/208,899

(22) Filed: May 15, 2025

(30) Foreign Application Priority Data
May 30, 2024 (JP) 2024-087841

(51) Int. Cl. G06T 7/00; B41J 3/28; B41J 11/00; G06K 15/02; G06V 10/74; G06V 10/764; G06V 30/19

(52) U.S. Cl. CPC G06T 7/0004; B41J 3/286; B41J 11/0095; G06K 15/1848; G06K 15/1894; G06V 10/761; G06V 10/764; G06V 30/19093; G06V 30/19173; G06K 2215/101; G06T 2207/30144

(57) ABSTRACT

Accuracy of the quality determination is improved while suppressing a wasteful spring. An ink jet printing apparatus includes: an ejection section that ejects ink toward an object to be drawn; an imaging section that captures an image of the object to be drawn and generates a captured image; a storage section that stores determination sensitivity indicating a degree of allowing disturbance in drawing; and a quality determination section that determines quality of a drawing state drawn on the object to be drawn by the captured image based on the determination sensitivity stored in the storage section.

### CROSS-REFERENCE TO RELATED APPLICATIONS

The present application claims foreign priority based on Japanese Patent Application No. 2024-087841, filed May 30, 2024, the contents of which are incorporated herein by reference.

### BACKGROUND OF THE INVENTION

### 1. Technical Field

The present disclosure relates to an ink jet printing apparatus and method.

### 2. Description of the Related Art

For example, a drop on demand (DOD) type ink jet printing apparatus that performs printing by ejecting ink onto a packaging material such as cardboard is known (See, for example, JP2014-144574A.).

Furthermore, there is also known a technique of capturing an image of a pattern drawn by the DOD-type ink jet printing apparatus with a camera and executing various applications (highly accurate alignment and the like) using the obtained captured image (See, for example, JP2020-131141A).

Here, for example, it is considered that whether or not a print content read by the camera matches a print content set in advance, that is, quality of the print content is determined, and in a case where the print content is determined to be defective, the output of the defect is performed. When image inspection is performed on print quality of cardboard by an ink jet printing apparatus, in a case where there is a black spot due to an individual difference between pieces of cardboard, dust attached to a surface of the cardboard, slight vibration of a conveyance line, or the like, there is a case where an erroneous determination is made in a defective direction although it is allowable in print quality, and such an erroneous determination is generally called a wasteful spring. Due to the wasteful spring, cardboard that does not need to be discharged is discharged from the conveyance line or the conveyance line is stopped, so that productivity is deteriorated.

In this regard, in JP2020-131141A, since the prevention of the wasteful spring is not specifically studied, the above-described deterioration of productivity cannot be avoided.

### SUMMARY OF THE INVENTION

The present disclosure has been made in view of such a point, and an object of the present disclosure is to improve accuracy of quality determination while suppressing a wasteful spring.

In order to achieve the above object, one embodiment of the present disclosure can be based on an ink jet printing apparatus that ejects ink for drawing information on an object and determines quality of a drawing state by imaging. The ink jet printing apparatus includes: an ink accommodation section that accommodates the ink; an ejection section that ejects the ink supplied from the ink accommodation section toward an object to be drawn; an imaging section that captures an image of the object to be drawn and generates a captured image; a storage section that stores determination sensitivity indicating a degree of allowing disturbance in drawing; and a quality determination section that determines quality of a drawing state drawn on the object to be drawn by the captured image based on the determination sensitivity stored in the storage section.

According to this configuration, when the quality of the drawing state drawn on the object to be drawn is determined by the captured image, the determination based on the determination sensitivity stored in the storage section is performed. Therefore, it is possible to suppress the determination of the object in the drawing state having no practical influence as a defect without deteriorating the determination accuracy, and the wasteful spring is reduced.

As described above, since the quality of the drawing state drawn on the object to be drawn is determined by the captured image on the basis of the determination sensitivity stored in the storage section, it is possible to improve the accuracy of the quality determination while suppressing the wasteful spring.

### BRIEF DESCRIPTION OF THE DRAWINGS

FIG. 1 is a diagram illustrating an overall configuration of an ink jet printing apparatus according to an embodiment of the present invention;

FIG. 2 is a block diagram of the ink jet printing apparatus;

FIG. 3 is a flowchart illustrating an example of processing when an image is classified;

FIG. 4 is a flowchart illustrating an example of secondary determination in processing when an image is classified;

FIG. 5 is a flowchart illustrating an example of processing of determining a reading character string from a captured image;

FIG. 6 is a diagram illustrating an example of a captured image and a reading result by an inspection machine based on the captured image;

FIG. 7 is a diagram illustrating a relationship between a captured image and a determination result;

FIG. 8 is a diagram illustrating an example of a window for changing a filter level and an allowable number of character string matches;

FIG. 9 is a flowchart illustrating an example of processing when drawing elements are classified;

FIG. 10 is a flowchart illustrating an example of processing when an image is classified in the image obtained by capturing a plurality of drawing elements; and

FIG. 11 is a flowchart illustrating an example of processing of distance notification.

### DETAILED DESCRIPTION

Hereinafter, embodiments of the present invention will be described in detail with reference to the drawings. It is to be noted that the following description of preferred embodiments is merely exemplary in nature and is not intended to limit the present invention, its application, or its use.

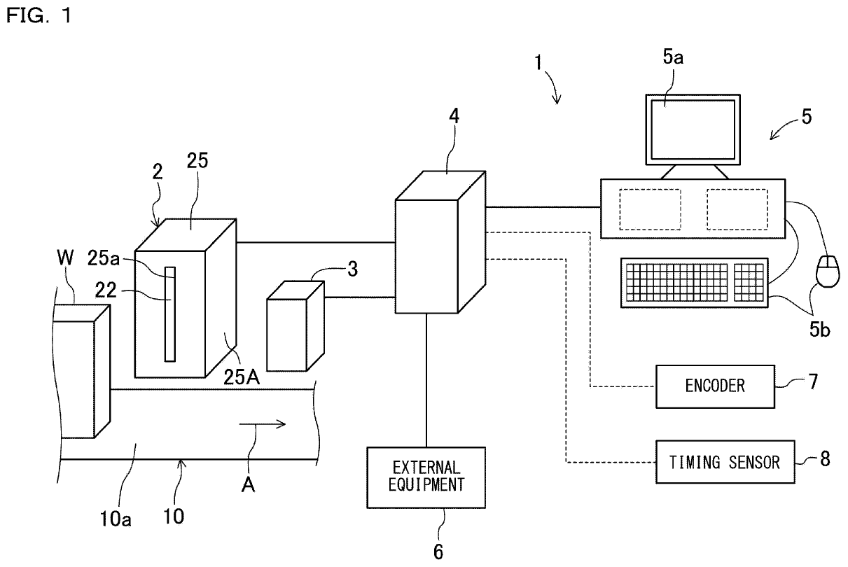

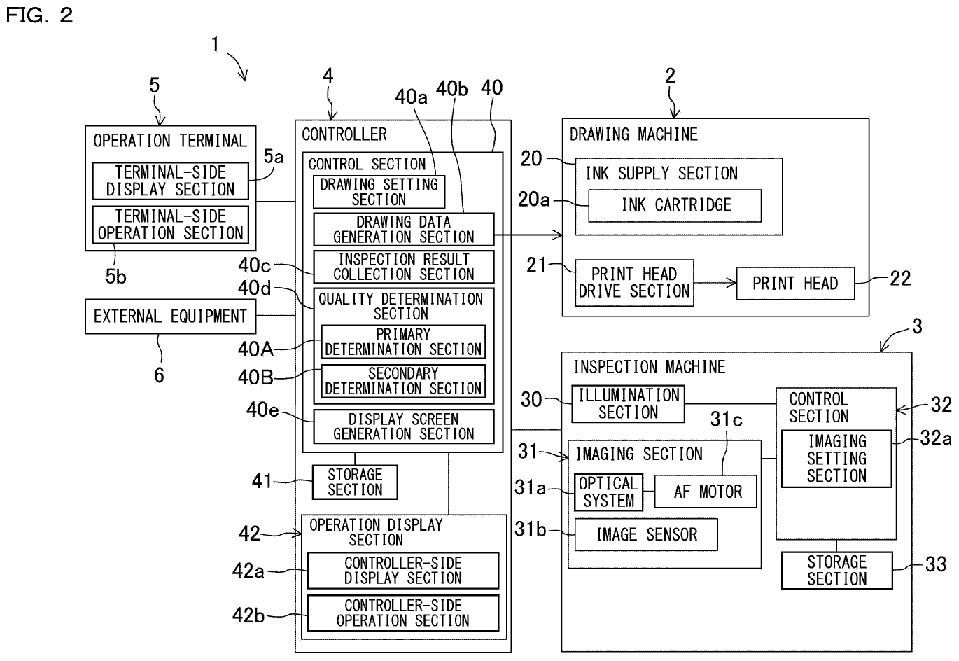

FIG. 1 is a diagram illustrating an overall configuration at the time of operation of an ink jet printing apparatus 1 according to an embodiment of the present invention, and FIG. 2 is a block diagram of the ink jet printing apparatus 1. The ink jet printing apparatus 1 includes, for example, a drawing machine 2, an inspection machine 3, a controller 4, and an operation terminal 5.

The drawing machine 2 is a part that performs a drawing process on an object to be drawn, and is configured separately from the controller 4. The inspection machine 3 is a part that determines the quality of the drawing state executed on the object to be drawn by the drawing machine 2, and is configured separately from the controller 4. Since the ink jet printing apparatus 1 according to the present embodiment includes the drawing machine 2 and the inspection machine 3, the ink jet printing apparatus 1 is an ink jet printing apparatus that ejects ink for drawing information on an object and determines the quality of a drawing state by imaging.

The controller 4 is a part that controls the drawing machine 2 and the inspection machine 3, and can also be referred to as a control device, a control unit, or the like. Furthermore, the operation terminal 5 includes a personal computer or the like, and is a portion where a user inputs drawing information, performs various settings, selects, confirms, and the like, for example. The operation terminal 5 includes a terminal-side display section 5a including, for example, a liquid crystal display and a terminal-side operation section 5b including a keyboard, a mouse, a pointing device, and the like.

The above configuration example is an example, and the present invention is not limited to the above configuration example. That is, the controller 4 may be incorporated in the operation terminal 5 or may be incorporated in the drawing machine 2. Furthermore, the operation terminal 5 may function as the controller 4. Furthermore, FIGS. 1 and 2 illustrate external equipment 6 including a programmable logic controller (PLC) or the like, and the external equipment 6 is communicably connected to the controller 4. A control signal output from the external equipment 6 is input to the controller 4. The external equipment 6 may be equipment constituting a part of the ink jet printing apparatus 1, or may be equipment different from the ink jet printing apparatus 1.

The ink jet printing apparatus 1 is a device for drawing various types of information on a workpiece W (an example of a drawing target object) conveyed by a conveyor 10, and is an in-line device used by being incorporated in a manufacturing line (also referred to as a production line). The conveyor 10 is, for example, a belt conveyor, a roller conveyor, or the like. The production line is configured by the conveyor 10. The production line is installed in various factories, warehouses, and the like. The drawing machine 2 is fixed such that the relative position with respect to the conveyor 10 has a predetermined positional relationship.

During operation of the ink jet printing apparatus 1, the plurality of workpieces W are sequentially conveyed in the direction of the arrow A illustrated in FIG. 1 in a state of being placed on a conveying surface 10a of the conveyor 10. Therefore, the upstream side in the conveyance direction is the left side in FIG. 1, and the downstream side in the conveyance direction is the right side in FIG. 1. The plurality of workpieces W are placed on the conveyance surface 10a in a state of being spaced apart from each other in the direction of the arrow A which is the conveyance direction. A direction orthogonal to the direction of the arrow A and along the conveyance surface 10a is defined as a width direction.

The workpiece W is not particularly limited, and examples thereof include a packing material for packing various products. As a typical example of the packing material, for example, cardboard and the like can be mentioned. The ink jet printing apparatus 1 draws information such as characters including numbers, symbols, bar codes, two-dimensional codes, images, marks, illustrations, combinations thereof, and the like on the workpiece W conveyed by the conveyor 10. In a case where only characters are drawn, the ink jet printing apparatus 1 can also be referred to as a printing apparatus or the like, and the drawing machine 2 can also be referred to as a printing machine. Furthermore, the drawing of information by the ink jet printing apparatus 1 also includes the case of printing an image or the like. In this case, the ink jet printing apparatus 1 can be referred to as a printing apparatus. In the following description, printing and print are simply referred to as drawing.

Furthermore, an encoder 7, a timing sensor 8, and the like for detecting the position of the workpiece W are connected to the controller 4. The controller 4 detects the position of the workpiece W based on signals output from the encoder 7 and the timing sensor 8. The controller 4 controls the drawing machine 2 so that drawing is started when the workpiece W reaches a predetermined position.

### (Configuration of Drawing Machine 2)

The drawing machine 2 is a drop on demand (DOD) type drawing machine that ejects ink only when necessary as a drawing operation, but may be a continuous ink jet (CIJ) type drawing machine that ejects ink even when the drawing operation is not performed, in addition to the DOD type drawing machine. Hereinafter, a case where a drawing machine of the DOD system is used as the drawing machine 2 of the present embodiment will be described.

As illustrated in FIG. 2, the drawing machine 2 includes an ink supply section 20, a print head drive section 21, and a DOD print head (Hereinafter, referred to as a print head.) 22. The drawing machine 2 also includes a main housing 25 (illustrated in FIG. 1) in which the print head 22 is provided. The main housing 25 is fixed to the conveyor 10 or the like.

The print head 22 is fixed in a state of being accommodated in the main housing 25, and a positional relationship between the main housing 25 and the print head 22 is fixed. Furthermore, the ink supply section 20 and the print head drive section 21 are also accommodated inside the main housing 25.

The print head 22 of the DOD type drawing machine 2 is a member corresponding to an ejection section, and ejects ink for drawing information on the workpiece W. There are a plurality of types of structures of the print head 22, and for example, any of a thermal ink jet type, a valve jet type, and a piezo type may be used. In the present embodiment, a piezoelectric print head capable of performing low resolution to high resolution drawing, having a wide drawing width, and having high durability is used as the print head 22.

In the print head 22, a plurality of ejection ports (not illustrated) are formed, for example, along the vertical direction. As illustrated in FIG. 1, an opening 25a that is long in the vertical direction is formed on a surface of the main housing 25 facing the workpiece W. The surface of the print head 22 on which the ejection port is formed is disposed so as to face the outside from the opening 25a of the main housing 25. Therefore, the ink ejected from the ejection port of the print head 22 jumps out of the main housing 25 from the opening 25a of the main housing 25 and adheres to the workpiece W.

The ink supply section 20 is a portion that supplies ink to the print head 22, and includes an ink cartridge 20a as an ink accommodation section that accommodates ink. Instead of the ink cartridge 20a, an ink reservoir (ink accommodation section) that can refill ink may be provided.

The print head drive section 21 is controlled by a control section 40 described later when performing the drawing operation. The print head drive section 21 generates a driving electric waveform for driving the print head 22 and outputs the driving electric waveform to the print head 22. The drive electric waveform is a waveform for individually driving the drive element (piezoelectric vibrator) provided for each ejection orifice of the print head 22 at a timing based on the drawing command output from the control section 40. The print head 22 discharges the ink supplied from the ink cartridge 20a toward the workpiece W to be drawn to draw on the workpiece W to be drawn.

### (Configuration of Inspection Machine)

The inspection machine 3 is a device that determines the quality of the drawing state related to the information drawn on the workpiece W to be drawn based on the drawing data by a captured image acquired by capturing an image of the workpiece W to be drawn, and corresponds to an image inspection section. Furthermore, the inspection machine 3 can also be referred to as an image inspection device. The inspection machine 3 is installed downstream of the drawing machine 2, and can inspect the drawing state of the workpiece W drawn by the drawing machine 2.

The inspection machine 3 includes an illumination section 30, an imaging section 31, a control section 32, and a storage section 33. The illumination section 30 includes, for example, a light emitting diode or the like, and is controlled by the control section 32 to emit light at a predetermined timing to illuminate a drawn portion of the workpiece W. The imaging section 31 includes an optical system 31a including a lens that receives light emitted from the illumination section 30 and reflected from the surface of the workpiece W, an image sensor 31b that receives light emitted from the optical system 31a, and an AF motor 31c. The AF motor 31c is a member for automatically focusing on the drawing portion of the workpiece W by driving the focusing lens of the optical system 31a. The autofocus method is not particularly limited, and examples thereof include a contrast method.

The image sensor 31b includes, for example, a complementary metal oxide semiconductor (CMOS) sensor or the like. The image sensor 31b images the workpiece W to be drawn and generates a captured image. For example, although not illustrated, the light reception amount signal of the light receiving element of the image sensor 31b is output to a field programmable gate array (FPGA) and processed, and is also output to a digital signal processor (DSP) and processed.

The control section 32 includes an imaging setting section 32a. The imaging setting section 32a is a portion that sets the imaging setting parameters and reflects the set imaging setting parameters at the time of imaging the workpiece W. The imaging setting parameters include, for example, a plurality of parameters such as timing of illumination by the illumination section 30, brightness (light emission amount), exposure time by the imaging section 31, and focus (focal position) of the imaging section 31. Although not illustrated, the GUI related to the setting of the imaging setting parameters is provided with an area in which brightness of illumination, exposure time, focus, and the like can be individually set. When the user inputs each parameter on the GUI, the imaging setting section 32a accepts a setting operation by the user, outputs each parameter to, for example, the storage section 33, and causes the storage section 33 to store the parameter. Each parameter can be read from the storage section 33 as necessary.

When acquiring the captured image data of the workpiece W, the imaging setting section 32a outputs the imaging setting parameters to the illumination section 30 and the imaging section 31. The illumination section 30 and the imaging section 31 operate according to the imaging setting parameters. Upon receiving the imaging setting parameter, the illumination section 30 sets the received imaging setting parameter in the imaging section 31 so as to reflect the received imaging setting parameter at the time of imaging. Furthermore, when receiving the imaging setting parameter, the imaging section 31 also sets the received imaging setting parameter in the imaging section 31 so as to reflect the received imaging setting parameter at the time of imaging. Upon receiving the imaging trigger, the illumination section 30 and the imaging section 31 illuminate the workpiece W in accordance with the imaging setting parameters and acquire captured image data of the workpiece W by imaging.

The control section 32 may be a part that executes the rule-based image inspection, a part that executes the image inspection using the pre-learned model, or a part that executes both the rule-based image inspection and the image inspection using the pre-learned model as the inspection tool. For example, the control section 32 causes the imaging section 31 to image the workpiece W, acquires captured image data of the workpiece W, and executes an inspection based on a set inspection tool on the acquired captured image of the workpiece W. When executing the inspection, the control section 32 cuts out a range to be inspected from the captured image. The control section 32 extracts a characteristic amount of the cut inspection range, and determines the extracted characteristic amount by a determination device. In a case where characters are included in the cut out inspection range, the inspection machine 3 can perform character recognition processing, so-called OCR, by using the dictionary when performing character recognition. Furthermore, in a case where a bar code or a two-dimensional code is drawn on the workpiece W, the bar code or the two-dimensional code can be read by the inspection machine 3.

After the determination by the inspection machine 3, the control section 32 creates an inspection result by the inspection tool and compares the inspection result with the inspection condition at this time. The inspection condition is acquired from a drawing data generation section 40b of the controller 4. For example, the result of the character recognition processing by the control section 32 is compared with the correct character string acquired from the drawing data generation section 40b, and it is determined as good in a case where they coincide with each other, and it is determined as poor in a case where they do not coincide with each other. In the case of a barcode or a two-dimensional code, the reading result of the control section 32 is compared with the code information acquired from the drawing data generation section 40b, and in a case where the reading result matches the code information, it is determined as good, and in a case where the reading result does not match the code information, it is determined as poor.

For example, in a case where there is one set inspection tool, the inspection result related to the set inspection tool is output as it is, but in a case where a plurality of set inspection tools is combined, the inspection result is further generated and output on the basis of the inspection result of each inspection tool.

The determination result by the inspection tool in the inspection machine 3 is not the final determination result of the ink jet printing apparatus 1, but is collected by the controller 4 to be described later, and the controller 4 performs the final quality determination based on the collected determination result. Details of quality determination processing by the controller 4 will be described later.

### (Configuration of Controller 4)

As illustrated in FIG. 2, the controller 4 includes the control section 40, a storage section 41, and an operation display section 42. The control section 40 includes, for example, a microcomputer including a central processing device, various memories, and the like, and can execute software stored in advance. The control section 40 is provided with a drawing setting section 40a, a drawing data generation section 40b, an inspection result collection section 40c, a quality determination section 40d, and a display screen generation section 40e. The drawing setting section 40a, the drawing data generation section 40b, the inspection result collection section 40c, the quality determination section 40d, and the display screen generation section 40c of the control section 40 are portions configured by hardware and software, and are described separately for convenience as the drawing setting section 40a, the drawing data generation section 40b, the inspection result collection section 40c, the quality determination section 40d, and the display screen generation section 40e, but may be integrated in hardware.

The operation display section 42 includes a controller-side display section 42a including, for example, a liquid crystal display and a controller-side operation section 42b including operation keys and the like. The controller-side operation section 42b receives various operations such as drawing contents and settings. Various screens generated by the display screen generation section 40e are displayed on the controller-side display section 42a, and the user can operate the controller-side operation section 42b while viewing the controller-side display section 42a. The operation state of the controller-side operation section 42b can be acquired by the control section 40.

The controller-side operation section 42b may be a touch panel. The touch panel is a member capable of detecting an operation by a user's finger. The type of the touch panel is not particularly limited, and examples thereof include a capacitance type and an infrared type. Operation information of the touch panel by the user is transmitted to the control section 40.

The drawing setting section 40a is a section that sets a drawing content to be drawn on the workpiece W to be drawn. The drawing content includes a character string, a barcode, a two-dimensional code, and the like to be drawn on the object to be drawn. The drawing setting section 40a can set a plurality of drawing contents. For example, a plurality of character strings can be drawn on one workpiece W, or a combination of a character string and a barcode or a two-dimensional code can be drawn on one workpiece W. The drawing data generation section 40b is a section that defines ejection of ink in the print head 22 and generates drawing data corresponding to the drawing content set by the drawing setting section 40a. The control section 40 outputs a control signal to the print head drive section 21 based on the drawing data generated by the drawing data generation section 40b, and controls ejection of ink from the ejection orifice of the print head 22.

The storage section 41 stores the determination sensitivity used in the quality determination by the quality determination section 40d. The determination sensitivity indicates a degree to which disturbance of drawing performed by the drawing machine 2 is allowed. Here, as illustrated in FIG. 1, it is assumed that a drawing target by the ink jet printing apparatus 1 is, for example, cardboard. There may be a black spot or dust on the surface of the cardboard, but such foreign matter often has no problem in practical use. However, when the image inspection is performed on the drawing quality of the surface of the cardboard, if the foreign matter is included in the image, there is a case where the inspection machine 3 erroneously determines in the defective direction although there is no practical influence, and such erroneous determination is generally called wasteful spring. Due to the wasteful spring, cardboard that does not need to be discharged is discharged from the conveyance line or the conveyance line is stopped, so that productivity is deteriorated.

On the other hand, in the present embodiment, in order to enhance the accuracy of the quality determination while suppressing wasteful springs, the inspection result collection section 40c collects the determination result of the inspection machine 3, and the quality determination section 40d performs the final quality determination based on the determination result collected by the inspection result collection section 40c. Specifically, the inspection machine 3 outputs the determination result in time series, and the inspection result collection section 40c collects the determination result output from the inspection machine 3 in time series. Imaging may be performed once for one drawing, and the inspection result collection section 40c may collect a plurality of determination results for a plurality of drawings in time series, or imaging may be performed a plurality of times for one drawing, and the inspection result collection section 40c may collect a plurality of determination results for one drawing in time series.

The quality determination section 40d determines the quality of the drawing state drawn on the object to be drawn from the captured image on the basis of the determination sensitivity stored in the storage section 41. Specifically, the quality determination section 40d includes a primary determination section 40A that classifies the captured image into a non-defective product image having a good drawing state, a defective product image having a defective drawing state, and an intermediate image having a non-defective drawing state but not satisfying a criterion for being determined to be good, and a secondary determination section 40B that classifies the intermediate image into either the non-defective product image or the defective product image on the basis of a determination result of the primary determination section 40A and the determination sensitivity.

Although not illustrated, the inspection machine 3 may be provided with a quality determination section. In this case, a part of the control section 32 of the inspection machine 3 can constitute the quality determination section. Furthermore, the determination processing by the control section 32 of the inspection machine 3 may be executed by the quality determination section 40d of the controller 4. Furthermore, the part that executes the determination processing in the control section 32 of the inspection machine 3 and the primary determination section 40A and the secondary determination section 40B in the controller 4 may be integrated to form the quality determination section.

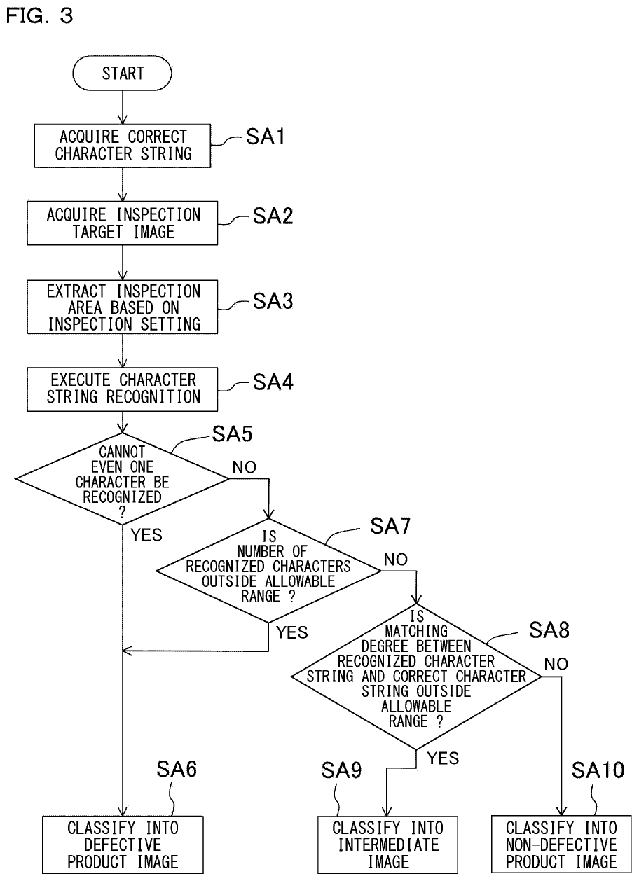

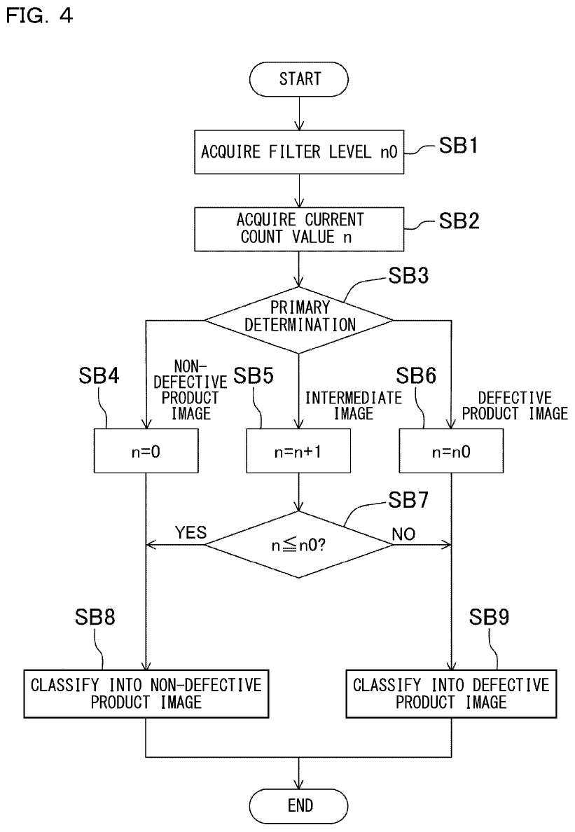

Hereinafter, the details of the determination processing by the primary determination section 40A of the quality determination section 40d will be described with reference to the flowchart illustrated in FIG. 3. Steps SA1 to SA4 after the start of this flowchart are executed by the inspection machine 3. In step SA1, the control section 32 of the inspection machine 3 acquires the correct character string from the drawing data generation section 40b. In step SA2, the control section 32 of the inspection machine 3 acquires the inspection target image (for example, a captured image 90 illustrated in FIG. 4) from the imaging section 31. In step SA3, an inspection area 91 to which the preset inspection tool is applied is extracted from the inspection target image 90. In step SA4, the control section 32 of the inspection machine 3 executes character recognition processing on the character string included in the inspection area 91 extracted in step SA3.

When the inspection result output from the inspection machine 3 is input to the quality determination section 40d, the primary determination section 40A of the quality determination section 40d refers to the inspection result in step SA5 and determines whether or not even one character cannot be recognized as a result of character recognition in step SA4. Since it is estimated that even one character cannot be recognized because the drawing state is bad and the characters cannot be read, the processing proceeds to step SA6 and classifies the image into a defective product image.

In a case where the primary determination section 40A determines NO in step SA5 and one or more characters can be recognized, the process proceeds to step SA7. In step SA7, the primary determination section 40A refers to the result of the character recognition in step SA4, and determines whether or not the number of characters that could be recognized characters (the number of recognized characters) is outside the allowable range. When the recognized number of characters is out of the allowable range, it is estimated that the drawing state is not good and there are few readable characters. Therefore, the process proceeds to step SA6, and the primary determination section 40A classifies the image into a defective product image. The number of characters serving as the determination threshold in step SA7 is set in advance by the user.

In a case where the primary determination section 40A determines NO in step SA5 and the recognized number of characters is within the allowable range, it is conceivable that the drawing state is relatively good, and for example, a part of characters cannot be read only by the presence of foreign matters (black circles denoted by reference numeral 92 in FIG. 4) on the surface of the cardboard. In such a case, the captured image 90 is not immediately classified into a defective product image, but the process proceeds to step SA8. In step SA8, the primary determination section 40A refers to the result of the character recognition in step SA4, and the primary determination section 40A determines whether or not the matching degree between the recognized character string and the correct character string is out of the allowable range. In a case where the recognized character is out of the allowable range, the process proceeds to step SA9, and the primary determination section 40A classifies the captured image 90 as an intermediate image. In a case where it is determined in step SA8 that the matching degree between the recognized character string and the correct character string is within the allowable range, the process proceeds to step SA10, and the primary determination section 40A classifies the captured image 90 into a non-defective product image. The matching degree serving as the determination threshold in step SA8 is set in advance by the user.

As described above, in steps SA7 and SA8, the captured image 90 is determined based on the determination threshold set by the user, and the captured image 90 is classified into three types of the defective product image, the intermediate image, and the non-defective product image. Therefore, it is possible to implement the inspection of the drawing quality according to the user's request.

Hereinafter, the details of the determination processing of determining the final determination result by the primary determination section 40A and the secondary determination section 40B of the quality determination section 40d for the quality of one image will be described with reference to the flowchart illustrated in FIG. 4. Steps SB1 to SB6 in this flowchart are executed by the controller 4. First, in step SB1, the filter level n0 is acquired. The filter level is a determination threshold indicating a degree to which continuation of the intermediate image is allowed at the time of determination by the primary determination section 40A, that is, the allowable number of times. The filter level is preset with a default value, and can also be edited by user input.

In step SB2, the current count value is acquired. The current count value is a value depending on the determination result for the images acquired in time series before the inspection target image, and a specific counting method will be described in a step described later.

In step SB3, as described above based on the flowchart illustrated in FIG. 3, the primary determination section 40A classifies the inspection target image into three types of a defective product image, an intermediate image, and a non-defective product image. In a case where the image is classified into the non-defective product image in the primary determination, the process proceeds to step SB4, the count value is set to 0, and the inspection target is classified into the non-defective product image as a final determination result.

In a case where the image is classified into the intermediate image in the primary determination, the process proceeds to step SB5, 1 is added to the current count value n, the process proceeds to step SB7, and the count value n and the filter level n0 are compared. When the count value is equal to or less than the filter level, it is determined that the number of times of continuation of the intermediate image is allowable, the process proceeds to step SB8, and the inspection target image is classified into the non-defective product image as the final determination result. On the other hand, in a case where the count value is larger than the filter level, it is determined that the number of times of continuation of the intermediate image exceeds the allowable number of times, the process proceeds to step SB9, and the inspection target image is classified into the defective product image as the final determination result.

In a case where the image is classified into the defective product image in the primary determination in step SB3, the process proceeds to step SB6, the count value is set to the filter level value n0, and the process proceeds to step SB9, and the inspection target image is classified into the defective product image as a final determination result. In a case where the image obtained in time series next to the image classified into the defective product image in the primary determination is classified into the intermediate image in the primary determination, the count value becomes larger than the filter level n0, and is classified into the defective product image as the final determination result regardless of the value of the filter level. Furthermore, the setting of the count value in the case of being classified into the defective product image in the primary determination is not the value of the filter level but a value obtained by adding 1 to the current count value similarly to the intermediate image, so that the filter level can be set to the degree of allowing continuation of the intermediate image or the defective product image.

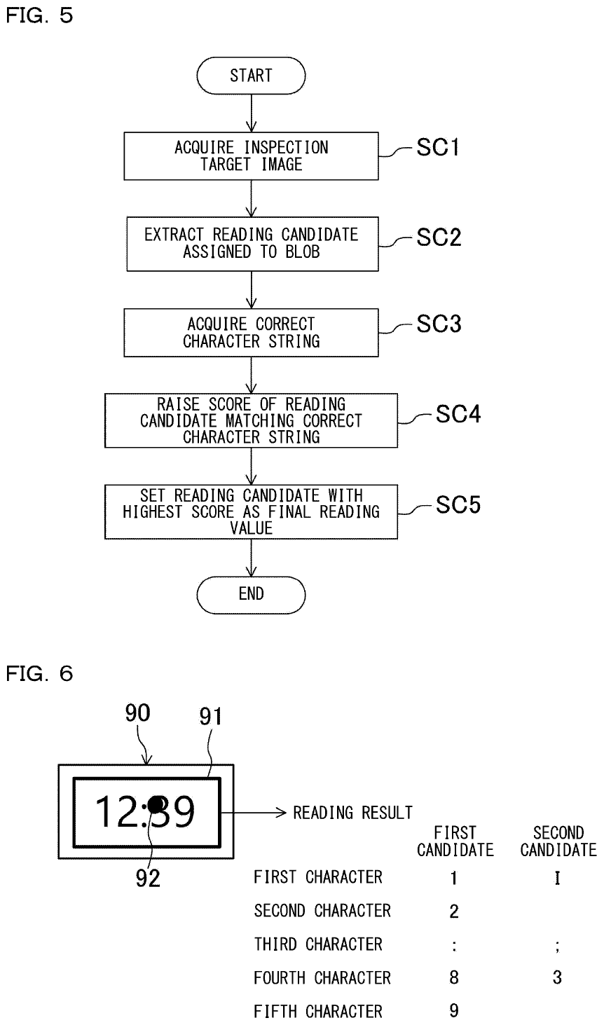

Hereinafter, a method of determining a reading character string of characters obtained from the acquired image to be used for collation recognition of the character string executed by the quality determination section 40d will be described in detail based on the flowchart illustrated in FIG. 5. Steps SC1 to SC5 of this flowchart are executed by the inspection machine 3. In step SC1, the control section 32 of the inspection machine 3 acquires the inspection target image (for example, the captured image 90 illustrated in FIG. 6) from the imaging section 3. In step SC2, the control section 32 of the inspection machine 3 recognizes a cluster (blob) of printing from the inspection target image 90 acquired in step SC1, calculates character similarity (reading score) based on the characteristic amount of the blob and extracts reading candidates, and arranges the first candidate and the second candidate in descending order of the reading score. In step SC3, the inspection machine 3 acquires a correct character string based on the drawing content set by the drawing setting section 40a of the controller 4. In step SC4, a character matching the acquired correct character string is searched from the extracted reading candidate, and the reading score of the matching reading candidate is raised. In step SC5, the reading candidate having the highest score is adopted as the final reading character string. In steps SC4 and SC5, instead of increasing the reading score, when a character matching the correct character string is a reading candidate, the character can be unconditionally adopted as the final reading character string.

In the example illustrated in FIG. 6, the number of characters constituting the character string included in the inspection area 91 of the captured image 90 is 5, and the correct character string is “12:39”. The quality determination section 40d gives a plurality of candidates for each of the first character, the second character, the third character, the fourth character, and the fifth character as a reading result. At this time, the quality determination section 40d executes collation recognition of the character string on the basis of the drawing content set by the drawing setting section 40a and the captured image captured by the imaging section 3, and calculates a reading score indicating similarity of characters in the collation recognition of the character string. A candidate having the highest reading score is the first candidate, and a candidate having a reading score lower than that of the first candidate is the second candidate. The third candidate and the fourth candidate may be cited as necessary.

Since the candidate having the highest reading score (first candidate) among the plurality of candidates is usually used as the reading result, “12:89” is read as the reading character string. Since this reading result is different from “12:39” of the correct character string, usually, the captured image 90 illustrated in FIG. 6 is classified into the defective product image.

In contrast to such normal processing, in the present embodiment, in a case where a character included in an accurate character string such as the second candidate of the third character is listed as a reading candidate, the quality determination section 40d performs processing of making the reading score of the second candidate character higher than that of the first candidate. Furthermore, the first candidate and the second candidate are given for each of the first character and the third character, and the second candidate of the first character is “I” of the alphabet, and the second candidate of the third character is “;”. The first candidate is correct for the first character and the third character.

For the fourth character, for example, since a foreign substance 92 such as a black spot is partially covered, a part of the fourth character is collapsed. Therefore, the first candidate of the fourth character is “8”, and the second candidate is “3”. Since the correct character string is known to be “12:39”, the reading score of the second candidate for the fourth character is increased to set the reading character string to “12:39”. As described above, in a case where a first candidate character and a second candidate character having a lower degree of similarity than the first candidate are obtained by collation recognition of a character string, when the second candidate character is included in the drawing content set by the drawing setting section 40a, the quality determination section 40d makes the score of the second candidate character higher than that of the first candidate character. Accordingly, a wasteful spring caused by an individual difference between pieces of cardboard, dust adhering to the surface of the cardboard, or the like is suppressed.

In a case where the correct character “3” is not listed as a candidate for the fourth character, the drawing state is estimated to be defective, and thus the captured image 90 is classified into the defective product image.

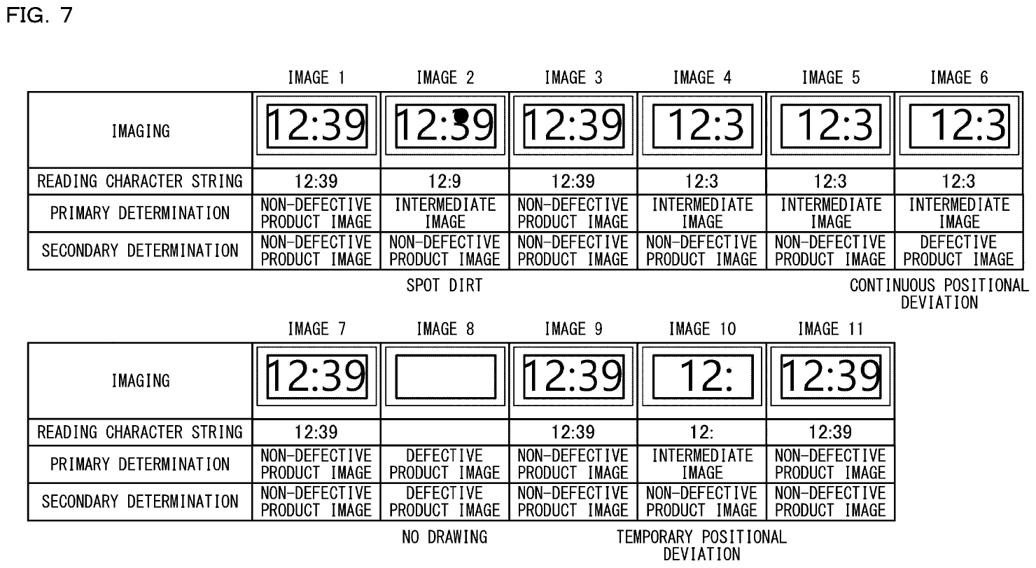

FIG. 7 illustrates a relationship among a reading character string of 12 captured images (images 1 to 12) acquired in time series, a primary determination result, and a secondary determination result. The primary determination result is a determination result by the primary determination section 40A, and the secondary determination result is a determination result by the secondary determination section 40B. The determination sensitivity is used at the time of determination by the secondary determination section 40B. The determination sensitivity includes a filter level indicating a degree of allowing continuation of the intermediate image or the defective product image at the time of determination by the primary determination section 40A, that is, the allowable number of times.

In a case where the number of times the intermediate image or the defective product image continues exceeds the allowable number of times, the secondary determination section 40B classifies the intermediate image determined by the primary determination section 40A into the defective product image, and when the number of times the intermediate image or the defective product image continues is less than or equal to the allowable number of times, the secondary determination section classifies the intermediate image determined by the primary determination section 40A into the non-defective product image.

In the example illustrated in FIG. 7, the filter level is “2”. Therefore, the secondary determination section 40B classifies the intermediate image determined by the primary determination section 40A into the defective product image in a case where the number of times the intermediate image or the defective product image continues exceeds 2, and classifies the intermediate image determined by the primary determination section 40A into the non-defective product image in a case where the number of times the intermediate image or the defective product image continues is less than or equal to 2.

Hereinafter, a specific description will be given. Since the reading character string matches the correct character string, the image 1 is classified into the non-defective product image in both the primary determination and the secondary determination. The image 2 is classified into the intermediate image in the primary determination because a foreign substance is applied to a part of the character string due to spot contamination and the reading character string is different from the correct character string, but is classified into the non-defective product image in the secondary determination because the number of consecutive times of the intermediate image or the defective product image in the primary determination is less than or equal to 2. Since the image 3 is similar to the image 1, the image 3 is classified into the non-defective product image in both the primary determination and the secondary determination.

The image 4 is classified into the intermediate image in the primary determination because a part of the drawing is missing and the reading character string is different from the correct character string, but is classified into the non-defective product image in the secondary determination because the number of consecutive times of the intermediate image or the defective product image is less than or equal to 2. Similarly to the image 4, the image 5 is classified into the intermediate image in the primary determination because a part of the drawing is missing and the reading character string is different from the correct character string. In the secondary determination, since the image 4 acquired before is the intermediate image, and the second intermediate image subsequent to the intermediate image is input as the image 5, the number of consecutive times of the intermediate image is 2, and the number of consecutive times is less than or equal to 2, the image 4 is classified into the non-defective product image in the secondary determination.

Similarly to the images 4 and 5, the image 6 is also classified into the intermediate image in the primary determination because a part of the drawing is missing and the reading character string is different from the correct character string. In the secondary determination, since both the image 4 and the image 5 acquired before are intermediate images, and the image 6 is also an intermediate image following the image 4 and the image 5, the number of times of consecutive intermediate images exceeds 2, which is the allowable number of times. In this case, the image 6 is classified into the defective product image by the secondary determination by the secondary determination section 40B. That is, in a case where the image 4 (first intermediate image) and the image 5 (second intermediate image) are acquired in time series by the imaging section 3, the secondary determination section 40B classifies the image 6 (third intermediate image) acquired after the acquisition of the image 5 into a defective product image.

Since the image 7 is similar to the image 1, the image 7 is classified into the non-defective product image in both the primary determination and the secondary determination. Since the image 8 does not include any character, the image 8 is classified into the defective product image in both the primary determination and the secondary determination regardless of the determination sensitivity. Since the image 9 is similar to the image 1, the image 9 is classified into the non-defective product image in both the primary determination and the secondary determination.

Since the image 10 does not include two characters and the reading character string is different from the correct character string, it is classified into the intermediate image in the primary determination. However, since the number of consecutive times of the intermediate image or the defective product image is less than or equal to 2, it is classified into the non-defective product image in the secondary determination. Since the image 11 is similar to the image 1, it is classified into the non-defective product image in both the primary determination and the secondary determination.

In the above description, as a method of counting the number of times that an image having a poor drawing state continues, a mode of adding one to the count of the number of consecutive times when the image is classified into either the intermediate image or the defective product image in the primary determination has been described. However, a mode of adding one to the count of the number of consecutive times only in a case where the image is classified into the intermediate image in the primary determination may be realized. In this case, the intermediate image continuously obtained next to the defective product image and the intermediate image further continuously obtained can be classified into the defective product image by the secondary determination regardless of the filter level.

In a case where the images classified into the intermediate images are not continuous as in the image 2 and the image 10, a cause of a small influence on the printing state, such as spot contamination or temporary positional deviation, can be considered. When spot contamination or temporary positional deviation occurs, the intermediate image is not continuous, so that the intermediate image can be classified into the non-defective product image in the secondary determination. On the other hand, as in the image 4 to 6, as a cause of the reading character string partially missing continuously, for example, occurrence of a situation continuously affecting the printing state such as a nozzle failure of the ink jet printing apparatus 1 is considered. When a nozzle failure occurs in the ink jet printing apparatus, the intermediate image is continuous, so that the intermediate image can be classified into the defective product image by the secondary determination. As described above, since the determination sensitivity of the quality determination section 40d includes the filter level, it is less likely that a defective product image is determined due to a small influence on the printing state, and a wasteful spring can be suppressed.

In the example illustrated in FIG. 7, the strictness of the inspection is determined from the allowable number of character string matches in the primary determination and the filter level included in the determination sensitivity in the secondary determination. For example, the smaller the value of the filter level, the more strict the inspection, and conversely, the larger the value of the filter level, the more loose the inspection. Furthermore, the smaller the allowable number of character string matches, the more strict the inspection, and conversely, the larger the allowable number of character string matches, the more loose the inspection.

The allowable number of character string matches may be set by an absolute value of the number of mismatched characters such as “mismatched a certain number of characters or more”, or may be set by a ratio (for example, %) of the degree of mismatching such as “mismatched a certain percentage or more”. Furthermore, in a case where it is desired to relax the inspection criteria in addition to matching/mismatching as characters, the “number of characters read” may be set as the allowable number. For example, in the case of a drawing content of eight characters, when a cluster (blob) of eight prints can be recognized, the image may be determined as a non-defective product image, or determination may be made based on the number of characters such as “a non-defective product image when the number of characters is eight characters±two characters”, and an allowable error may be given to the determination. In short, in a case where the inspection is strictly performed, the value of the filter level is reduced, and the allowable number of character string matches is also reduced. Conversely, in a case where the inspection is loosened, the value of the filter level is increased, and the allowable number of character string matches is increased. In this manner, by allowing the determination sensitivity and the allowable number of character string matches to be changed in a set, the convenience of the user is enhanced. However, the filter level and the allowable number of character string matches may be changed separately.

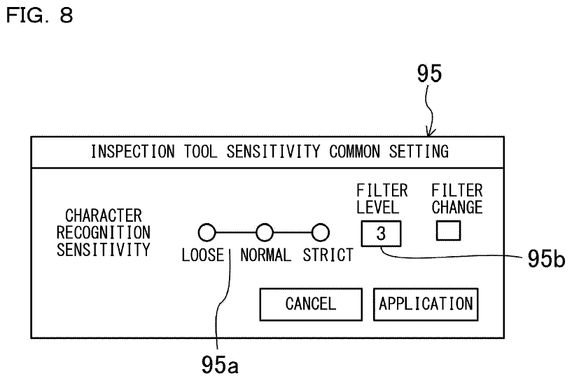

FIG. 8 illustrates a change window 95 for changing the allowable number of character string matches and the filter level. The change window 95 is provided with a character recognition sensitivity changing area 95a for changing the character recognition sensitivity. When the user operates the character recognition sensitivity changing area 95a, the character recognition sensitivity can be changed to a plurality of stages of “gentle”, “normal”, and “strict”, for example. Note that the character recognition sensitivity may be input as a numerical value, such as the allowable number of times described above.

The change window 95 is also provided with a filter level changing area 95b for changing the filter level. The number input to the filter level changing area 95b is received as an allowable number of character string matching. The change result of the character recognition sensitivity changing area 95a and the input operation to the filter level changing area 95b are received by the controller-side operation section 42b. Therefore, the controller-side operation section 42b is an input section that receives an input of the filter level and the allowable number of character string matches by the user. The filter level and the allowable number of character string matches received by the controller-side operation section 42b are stored in the storage section 41. The quality determination section 40d acquires the filter level and the allowable number of character string matches stored in the storage section 41, and applies the filter level and the allowable number of character string matches in the primary determination and the secondary determination.

In a case where a plurality of drawing elements is set, the determination sensitivity can be changed for each drawing element. For example, when the change of the determination sensitivity of the first drawing element is completed, the changed determination sensitivity is stored in the storage section 41 in association with the first drawing element. Thereafter, when the change in the determination sensitivity of the second drawing element is completed, the changed determination sensitivity is stored in the storage section 41 in association with the second drawing element. In this manner, the determination sensitivity is stored in the storage section 41 for each drawing element. The quality determination section 40d determines the quality of the drawing state based on the corresponding determination sensitivity for each drawing element. For example, since the number indicating the best-before date is important information, strict inspection can be performed, and since the lot number is used for internal determination, a loose reference can be used.

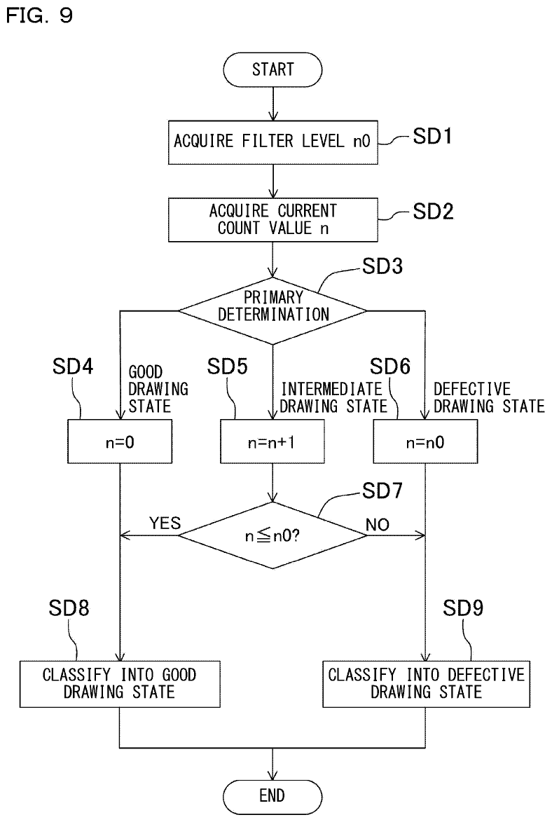

The flowchart of FIG. 9 illustrates processing of the inspection tool executed to determine the quality of the drawing state based on the determination sensitivity for each drawing element. The determination as to whether the drawing state of the drawing element is good or bad can be realized by a method similar to the description of the flowchart for determining the quality of the image based on the flowchart of FIG. 4 described above. That is, the filter level n0 is acquired in step SD1. Furthermore, in step SD2, the current count value is acquired. In step SD3, the primary determination section 40A classifies the drawing state of the inspection target image into three types of a good drawing state, an intermediate drawing state, and a defective drawing state.

In a case where the image is classified into the good drawing state in the primary determination, the process proceeds to step SD4, the count value is set to 0, and the inspection target is classified into the good drawing state as a final determination result.

In a case where it is classified into the intermediate drawing state in the primary determination, the process proceeds to step SD5, 1 is added to the current count value n, the process proceeds to step SD7, and the count value n and the filter level n0 are compared. When the count value is less than or equal to the filter level, it is determined that the number of times the intermediate drawing state continues is allowable, the process proceeds to step SC8, and the inspection target image is classified into the good drawing state as the final determination result. On the other hand, in a case where the count value is larger than the filter level, it is determined that the number of times the intermediate drawing state continues exceeds the allowable number, the process proceeds to step SD9, and the inspection target image is classified into the defective drawing state as the final determination result.

In a case where the image is classified into the defective drawing state in the primary determination in step SD3, the process proceeds to step SD6, the count value is set to the filter level value n0, and the process proceeds to step SD9, and the inspection target image is classified into the defective drawing state as the final determination result. In a case where images obtained in time series next to the image classified into the defective drawing state by the primary determination are classified into the intermediate drawing state by the primary determination, the count value becomes larger than the filter level n0, and the inspection target image is classified into the defective drawing state as the final determination result regardless of the value of the filter level.

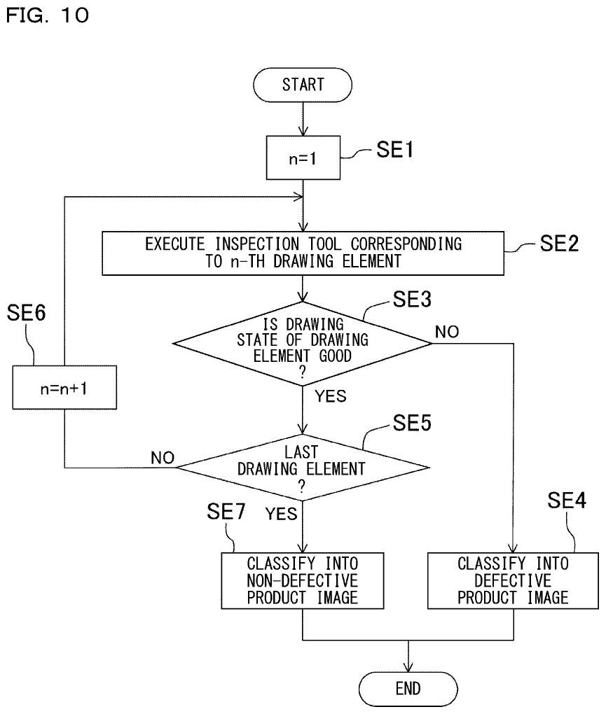

Hereinafter, details of the image inspection in a case where a plurality of drawing elements is arranged will be described with reference to the flowchart illustrated in FIG. 10. The processing of this flowchart is executed by the controller 4.

In step SE1, an initial value 1 of the count value is set. In step SE2, the inspection tool corresponding to the drawing element corresponding to the current count value is executed, and in step SE3, the quality of the drawing state is determined. When the drawing state of the drawing element is defective in step SE3, the process proceeds to step SE4, and the inspection target image is classified into the defective product image. When the drawing state is good in step SE3, the process proceeds to step SE5, and it is determined whether or not it is the last drawing element. In a case where the current drawing element is not the last drawing element, the process proceeds to step SE6, the count value is added by one, and the inspection tool is executed on the next drawing element. This processing is repeated until the last drawing element is obtained, and in a case where the drawing states of all the drawing elements are good, the image is classified into the non-defective product image in step SE7.

The determination sensitivity may include a score indicating a degree of similarity of a character in collation recognition of a character string. As described above, when collation recognition of the character string is executed on the basis of the drawing content set by the drawing setting section 40a and the captured image captured by the imaging section 3, the quality determination section 40d calculates and stores the score indicating the similarity of the characters in the collation recognition of the character string. Since this score is included in the determination sensitivity, the captured image can be classified based on the score.

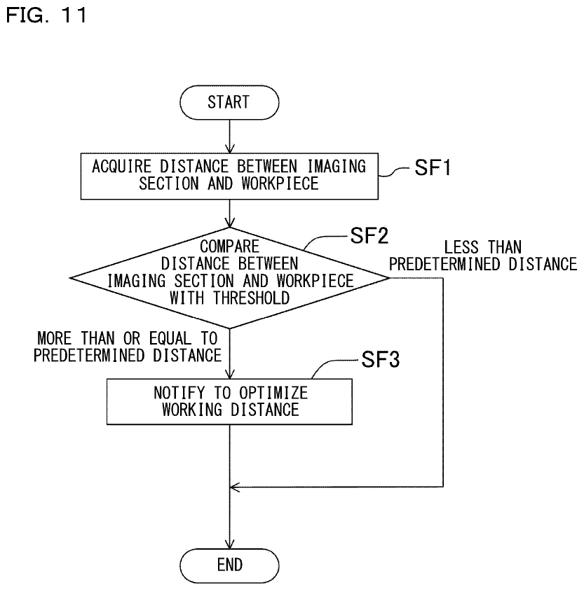

A method of determining whether or not a working distance is a cause in a case where the inspection target image is classified as the defective product image by the quality determination section 40d, and notifying the user to optimize the working distance as necessary, based on the flowchart illustrated in FIG. 11, will be described in detail. In step SF1, the control section 40 of the controller 4 acquires a distance (working distance) between the imaging section 3 and the workpiece W. The distance between the imaging section 31 and the workpiece W to be drawn may be measured and input by the user, may be set in advance, or may be estimated from the driving amount of the lens by the AF motor 31c.

In step SF2, the control section 40 determines whether the distance between the imaging section 3 and the workpiece W is more than or equal to a predetermined distance set as a determination threshold. As a result of the determination in step SF2, when the distance between the imaging section 3 and the workpiece W is more than or equal to the predetermined distance, the process proceeds to step SF3, and the working distance is displayed on the controller-side display section 42a together with the determination result of the quality determination section 40d in order to notify the user that the working distance is more than or equal to the predetermined distance. The controller-side display section 42a is a notification section for notifying the user that the working distance is more than or equal to the predetermined distance together with the determination result of the quality determination section 40d.

The above-described embodiments are merely examples in all respects, and should not be construed in a limiting manner. Moreover, all modifications and changes falling within the equivalent scope of the claims are within the scope of the present invention. That is, in addition to the character recognition, the present invention can be applied to inspection by the inspection machine 3 in a case where a bar code or a two-dimensional code is drawn. There is a “grade” indicating the reading quality of a barcode or a two-dimensional code, and a user expects that a certain code printing quality has been achieved, and may set the code inspection threshold as “grade C or higher”. At this time, in a case where the grade of the reading result is less than or equal to a predetermined value (for example, grade D), as in the case of the character string, an intermediate image is determined by the primary determination. In a case where the code cannot be read at all, the image is classified into the defective product image by the primary determination. In the case of the barcode or the two-dimensional code, the grade is set as the determination sensitivity, and the determination sensitivity is set similarly to the case of the character string, so that it is possible to reduce a wasteful spring even in the drawing and inspection of the barcode or the two-dimensional code.

As described above, the present disclosure can be used, for example, in a case where various types of information are drawn on a packaging material such as cardboard.

What is claimed is:

1. An ink jet printing apparatus that ejects ink for drawing information on an object and determines quality of a drawing state by imaging, the ink jet printing apparatus comprising:
an ink accommodation section that accommodates the ink;
an ejection section that ejects the ink supplied from the ink accommodation section toward an object to be drawn;
an imaging section that captures an image of the object to be drawn and generates a captured image;
a storage section that stores determination sensitivity indicating a degree of allowing disturbance in drawing; and
a quality determination section that determines quality of a drawing state on the object to be drawn based on the captured image and the determination sensitivity stored in the storage section.

2. The ink jet printing apparatus according to claim 1, wherein
the quality determination section includes: a primary determination section that classifies the captured image into a non-defective product image having a good drawing state, a defective product image having a defective drawing state, and an intermediate image having a non-defective drawing state but not satisfying a criterion of being determined to be good; and a secondary determination section that classifies the intermediate image into either the non-defective product image or the defective product image based on a determination result of the primary determination section and the determination sensitivity.

3. The ink jet printing apparatus according to claim 2, wherein in a case where the imaging section acquires a first intermediate image and a second intermediate image in time series, the secondary determination section classifies a third intermediate image acquired after the acquisition of the second intermediate image as the defective product image.

4. The ink jet printing apparatus according to claim 2, wherein
the determination sensitivity includes an allowable number of times of allowing continuation of the intermediate image or the defective product image in determination by the primary determination section, and
in a case where the number of times of continuation of the intermediate image or the defective product image exceeds the allowable number of times, the secondary determination section classifies the intermediate image as the defective product image, and in a case where the number of times of continuation of the intermediate image or the defective product image is less than or equal to the allowable number of times, the secondary determination section classifies the intermediate image as the non-defective product image.

5. The ink jet printing apparatus according to claim 2, wherein
the determination sensitivity includes an allowable number of times of allowing continuation of the intermediate image in determination by the primary determination section, and
in a case where the number of times of continuation of the intermediate image exceeds the allowable number of times, the secondary determination section classifies the intermediate image as the defective product image, and in a case where the number of times of continuation of the intermediate image is less than or equal to the allowable number of times, the secondary determination section classifies the intermediate image as the non-defective product image.

6. The ink jet printing apparatus according to claim 4, further comprising a drawing setting section that sets a character string to be drawn on the object to be drawn as a drawing content,
wherein the quality determination section executes collation recognition of the character string based on the drawing content set by the drawing setting section and the captured image captured by the imaging section, and
the determination sensitivity further includes a score indicating similarity of characters in the collation recognition of the character string.

7. The ink jet printing apparatus according to claim 6, wherein in a case where a first candidate character and a second candidate character having a lower similarity than the first candidate character are obtained by the collation recognition of the character string, the quality determination section makes a score of the second candidate character higher than a score of the first candidate character when the second candidate character is included in the drawing content set by the drawing setting section.

8. The ink jet printing apparatus according to claim 1, further comprising an input section that receives an input of the determination sensitivity by a user,
wherein the storage section stores the determination sensitivity received by the input section.

9. The ink jet printing apparatus according to claim 1, further comprising a notification section that, when a determination result of the quality determination section is a defective product image and a distance between the imaging section and the object to be drawn is more than or equal to a predetermined distance, notifies a user that the distance between the imaging section and the object to be drawn is more than or equal to the predetermined distance together with the determination result.

10. The ink jet printing apparatus according to claim 1, further comprising a drawing setting section capable of setting a plurality of drawing elements,
wherein the storage section stores the determination sensitivity for each of the drawing elements, and
the quality determination section determines the quality of the drawing state based on the determination sensitivity for each of the drawing elements.

11. A method of drawing information by ejecting ink on an object and determining quality of a drawing state on the object by imaging, the method comprising the step of:
receiving an input of determination sensitivity from a user via an input section,
wherein the determination sensitivity indicates a degree of allowing disturbance in drawing;
storing the determination sensitivity with a storage section;
ejecting ink supplied from an ink source toward an object to be drawn using an ejection section;
capturing an image of the object to be drawn and generating a captured image using an imaging section; and
determining quality of a drawing state on the object to be drawn based on the captured image and the determination sensitivity stored in the storage section.
